(19) United States
(12) Patent Application Publication
(10) Pub. No.: US 2005/0243934 A1
(43) Pub. Date: Nov. 3, 2005

(54) Processing auxiliary data of video sequences

(76) Inventors: Lothar Werner, Rodgau (DE); Thilo Landsiedel, Rodgau (DE)

Correspondence Address: WENDEROTH, LIND & PONACK, L.L.P., 2033 K STREET N. W., SUITE 800, WASHINGTON, DC, 20006-1021, US

(21) Appl. No.: 11/116,250

(22) Filed: Apr. 28, 2005

(30) Foreign Application Priority Data
Apr. 30, 2004 (EP) 04010302.0

(51) Int. Cl. H04N 7/12

(52) U.S. Cl. 375/240.24; 348/700

(57) ABSTRACT

The present invention to a pre-processing of auxiliary data of a video sequence in order to enable improved processing results for applying picture improvement algorithms. Irregularities occurring within an auxiliary data field providing data items on a block basis are detected and removed. In particular, a film/video indication or a motion/still indication is processed accordingly. The removal of irregularities enables a respective improved image processing, for instance, interpolation processing during up-conversion.

The present invention relates to a method and signal processor for processing auxiliary data of video sequences. In particular, the present invention relates to a pre-processing of auxiliary data of video sequences in order to achieve an improved processing of video sequences, in particular for interpolation purposes.

Motion estimation is employed in an increasing number of applications, in particular, in digital signal processing of modern television receivers. Specifically, modern television receivers perform a frame-rate conversion, especially in form of an up-conversion or motion compensated up-conversion, for increasing the picture quality of the reproduced images. Motion compensated up-conversion is performed, for instance, for video sequences having a field or frame frequency of 50 Hz to higher frequencies like 60 Hz, 66.67 Hz, 75 Hz, 100 Hz etc. While a 50 Hz input signal frequency mainly applies to television signal broadcasts based on PAL or SECAM standard, NTSC based video signals have an input frequency of 60 Hz. A 60 Hz input video signal may be up-converted to higher frequencies like 72 Hz, 80 Hz, 90 Hz, 120 Hz etc.

During up-conversion, intermediate images are to be generated, which reflect the video content at positions in time which are not represented by the 50 Hz or 60 Hz input video sequence. For this purpose, the motion of objects has to be taken into account in order to appropriately reflect the changes between subsequent images caused by the motion of objects. The motion of objects is calculated on a block basis, and motion compensation is performed based on the relative position in time of the newly generated image between the previous and subsequent images.

In order to enable a processing of picture improvement algorithms, a number of characteristic information items of the video sequence to be processed are required. These information items are preferably obtained on a block basis. The characteristic information include data indicating whether a block includes still image data or moving image data, data indicating whether or not the image information of a block stem from motion pictures (film mode), and data indicating the motion phase pattern in case of film mode. These data enable a selection of the appropriate image data for interpolation purposes.

The present invention aims to enable an image processing with improved picture quality based on an enhancement of auxiliary data of a video sequence to be processed.

This is achieved by the features of the independent claims.

According to a first aspect of the present invention, a method for processing auxiliary data of a sequence of video images is provided. The auxiliary information is received in form of a field including an information item for each of the blocks of an image. The received field of auxiliary information is subjected to filtering in order to detect and eliminate an irregularity.

According to a further aspect of the present invention, a signal processor is provided for processing auxiliary data of a sequence of video images. The signal processor receives a field of auxiliary information. Each video image is divided into a plurality of blocks and the field of auxiliary information includes an information item for each of the blocks of an image. The signal processor comprises a filter means for subjecting the received field of auxiliary information to filtering in order to detect and eliminate an irregularity.

It is the particular approach of the present invention to detect abnormal patterns of auxiliary information and to eliminate such patterns therefrom. In this manner, an auxiliary information item reflecting an abnormal behavior compared to its surrounding is eliminated and replaced by a more likely information value. Accordingly, a picture improvement processing is able to apply a smoothened field of auxiliary information as implausible information items are replaced by more plausible ones.

Preferably, the auxiliary information represents characteristic information of the video sequence. By applying the present invention, defective determinations can be removed from the auxiliary data.

According to a preferred embodiment, the auxiliary information indicates whether or not an image block contains motion or still image data. Accordingly, the application of a motion compensated interpolation can be put on a more reliable basis by removing unlikely data items.

Preferably, a single bit is provided for each block in order to indicate motion or still image data.

Preferably, the auxiliary information includes information indicating whether or not an image block contains film mode or video mode data. Most preferably, a single bit is provided therefore. By removing unlikely film mode or video mode indications, an improved motion compensated interpolation result can be achieved.

Preferably, the auxiliary information further indicates an individual motion scheme of a film mode block. In this manner, a picture quality improvement algorithm can accurately take the motion phase pattern of pull down schemes into account during interpolation processing.

Preferably, three bits are provided for the indication of an individual motion scheme. Most preferably, these three bits indicate at least two bit combinations representing a PAL motion phase pattern, five bit combinations which represent NTSC motion phase pattern and a single bit combination representing an image scene change. In this manner, a small number of bits can be used to represent all most likely pull down motion patterns for world-wide applications.

Preferably, the filtering is performed either in row or column direction. In this manner, an irregularity can be efficiently detected by employing only a small computational effort.

Preferably, those auxiliary data items are removed which do not have at least two neighboring data items of a corresponding value in horizontal or vertical direction. According to an alternative embodiment, individual auxiliary data items are removed which do not have at least a single neighboring data item of a corresponding value in horizontal and at least a single neighboring data item of a corresponding value in vertical direction. According to another alternative embodiment, auxiliary data items are removed which do not have at least two corresponding data items at an adjacent position. Accordingly, individual regularities can efficiently be removed from the field of the data items.

Preferably, the removed data item is replaced by the data item of a neighboring block. In this manner, an efficient concealment scheme with low computational and hardware effort can be applied.

Preferably, the detection of an irregularity is performed by comparing a current pattern of block data with pre-stored irregularity patterns. Upon detecting the current pattern to match a pre-stored irregularity pattern, the current pattern is replaced. By providing a plurality of predefined irregularity patterns, possible irregularity configurations can reliably be detected and removed.

Preferably, a replacement pattern is stored in association with a respective irregularity pattern. Consequently, the most appropriate replacement pattern is available upon detecting an irregularity based on a stored regularity pattern.

While an embodiment of low hardware complexity employs patterns of a three data items length, a more sophisticated approach employs a pattern extending in two directions. Such a two dimensional pattern approach enables to detect a plurality of unlikely irregularities with increased efficiency and reliability.

Preferred embodiments of the present invention are the subject matter of the dependent claims.

Other embodiments and advantages of the present invention will become more apparent from the following description of preferred embodiments, in which:

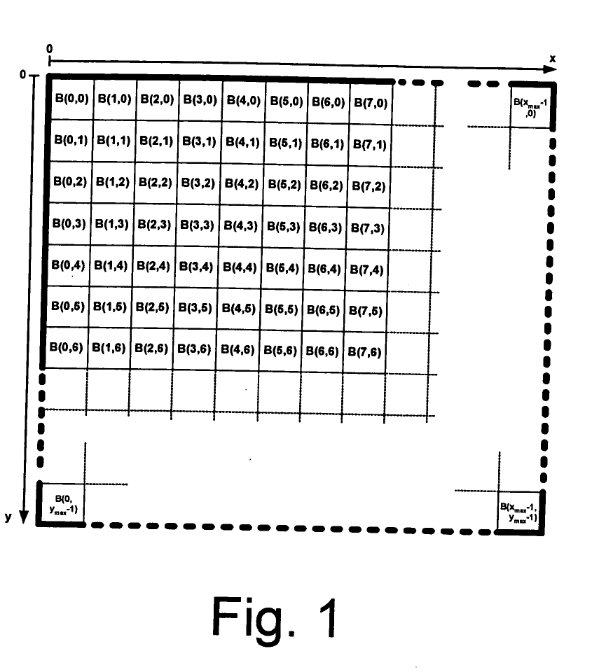

FIG. 1 illustrates an example for dividing a video image into plurality of blocks of uniform size,

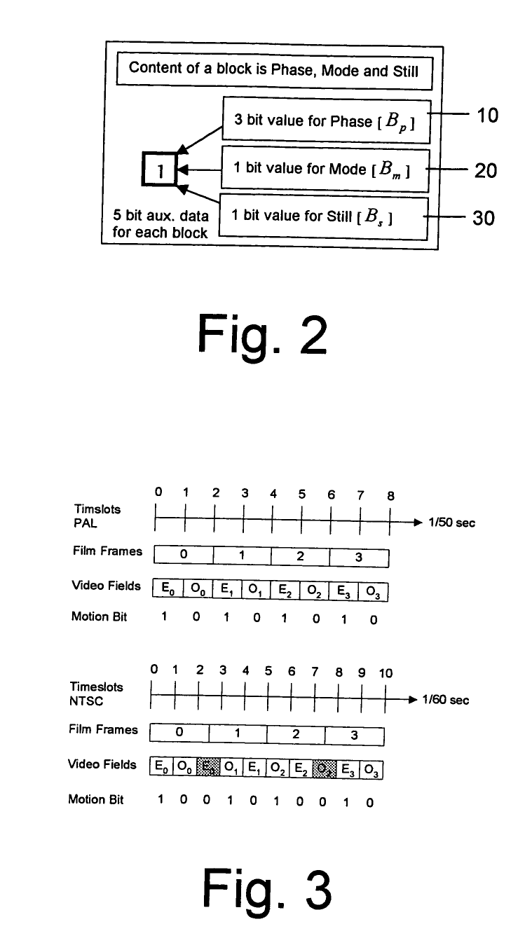

FIG. 2 illustrates examples for auxiliary information provided for each block of a video image,

FIG. 3 illustrates examples for common pull down schemes in order to convert motion picture data into interlaced PAL and NTSC video sequences,

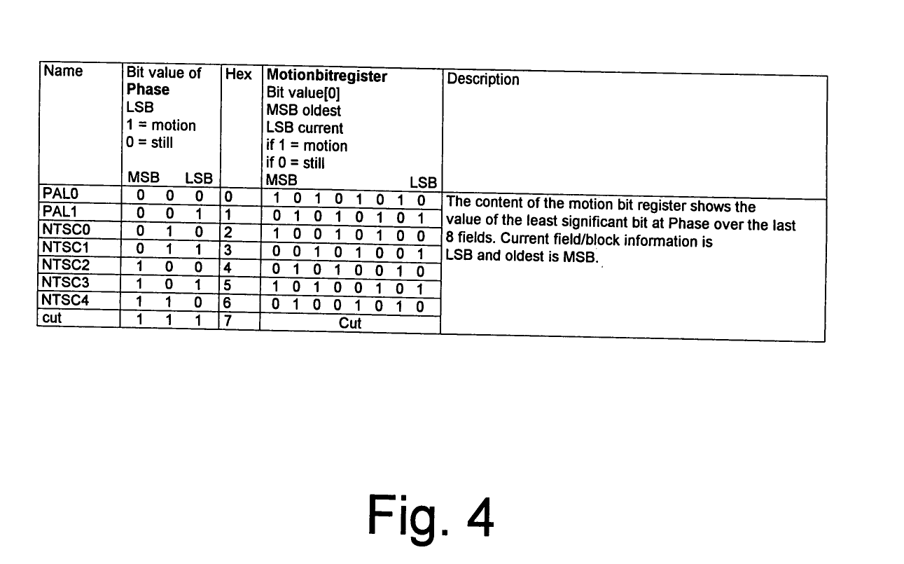

FIG. 4 illustrates an example encoding of auxiliary data indicating a motion phase,

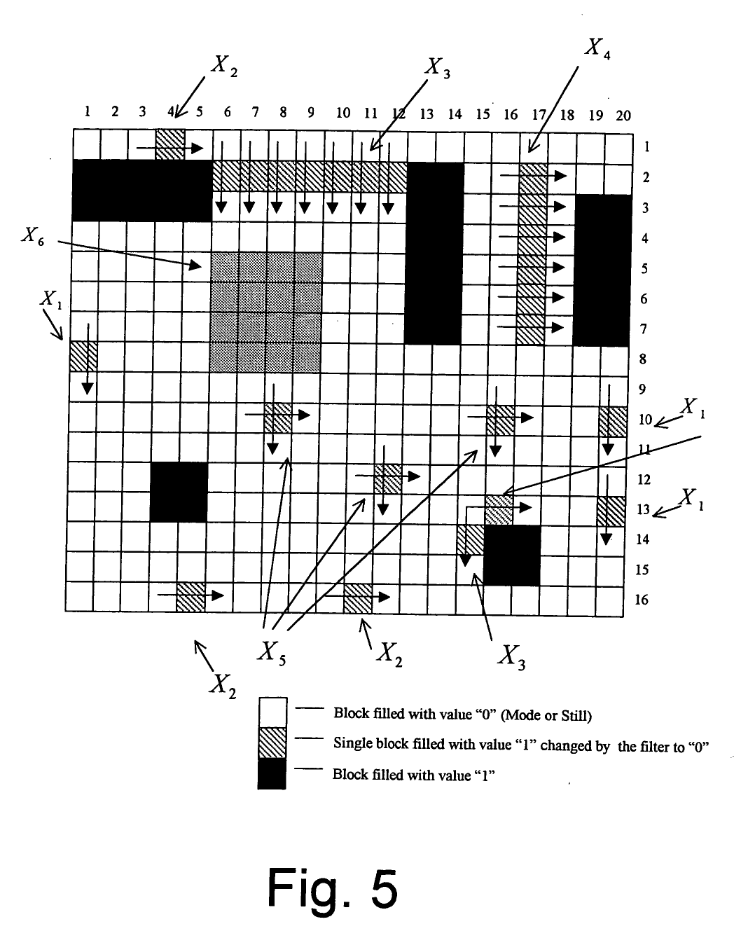

FIG. 5 illustrates an example field of auxiliary data wherein individual irregularities are removed by applying a horizontal and vertical filtering,

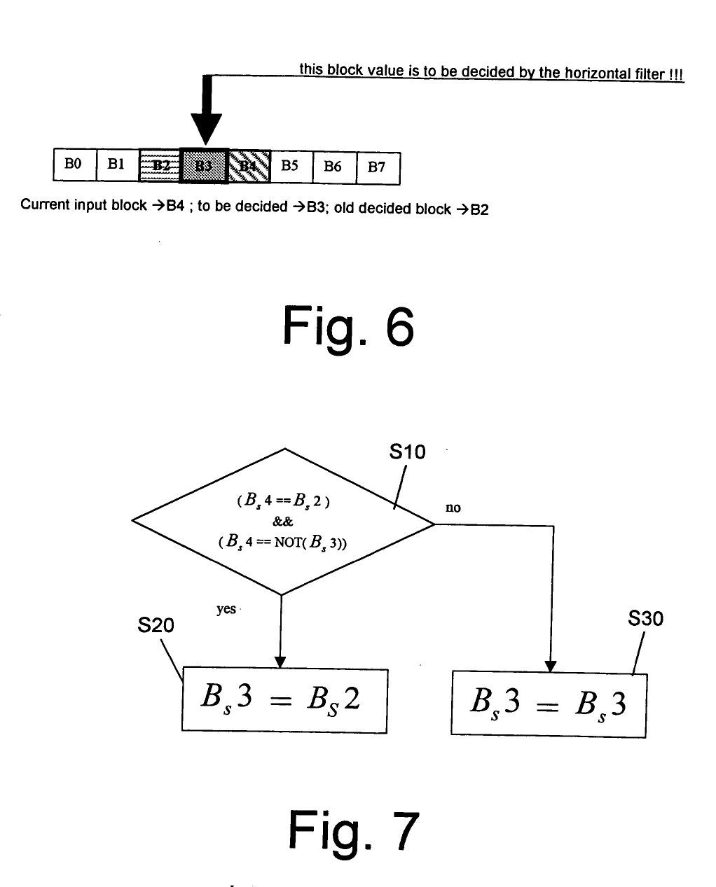

FIG. 6 illustrates the application of a horizontal filtering in order to remove irregularities of one block width,

FIG. 7 is a flowchart showing the steps for a filter processing,

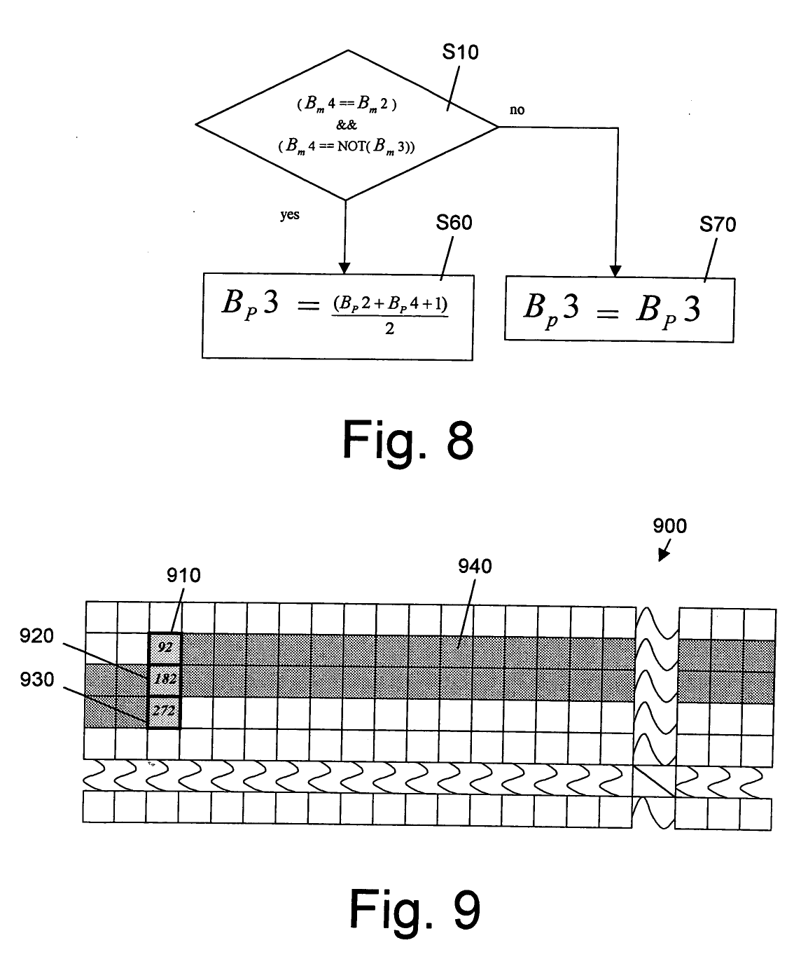

FIG. 8 is a flowchart showing the steps for a filter processing to be applied to motion phase data upon replacing a mode data item, and

FIG. 9 illustrates the memory capacity required for a respective vertical filtering.

The present invention relates to digital signal processing, especially to signal processing in modern television receivers. Modern television receivers employ up-conversion algorithms in order to increase the reproduced picture quality. For this purpose, intermediate images are to be generated from two subsequent images. For generating an intermediate image, the motion of objects has to be taken into account in order to appropriately adapt the object position to the point of time reflected by the interpolated image.

Motion estimation is performed on a block basis. For this purpose, each received image is divided into a plurality of blocks as illustrated in FIG. 1. Each current block is individually subjected to motion estimation by determining a best matching block in the previous image.

FIG. 1 illustrates the division of each video image into a plurality of blocks B(x,y). Each block has a width X and a height Y wherein X and Y represent the number of pixels in the line and column direction, respectively. The number of blocks per row or column can be calculated by employing the following formulas:
xₘₐₓ=Pixels per line/X
yₘₐₓ=Pixels per column/Y

The digital signal processing in modern television receivers applies picture improvement algorithms, which make use of auxiliary data reflecting characteristic information of the video sequence to be processed. For this purpose, a still image/motion image indication, a film/video indication and a motion phase indication are preferably included on a block basis into the auxiliary data. These data result from a Block Mode Detection (BMD) processing. The block mode detection is part of a feature for modern media display devices like CRT, TFT or plasma displays. It is the main function of BMD to automatically select the settings for signal processing in order to achieve the best picture quality of the current video data.

The auxiliary information is available for each block of each incoming video field, wherein the individual data items are stored in form of a block matrix. Examples of the individual information retrieved for each block is illustrated in FIG. 2. As can be seen therefrom, for each block, the auxiliary information includes a still/motion indication 30, a film/video mode indication 20, and a motion phase indication 10.

The motion/still information 30 is one bit wide (Bₛ) and enables to determine whether or not the current block of the input field relates to a moving or still object. If a still block is indicated, the image data from two subsequent fields can be used for re-interleaving in order to achieve the best picture quality output. Preferably, the sill/motion bit is defined as follows:
0=motion
1=still

A further bit (Bₘ) is employed in order to indicate film mode or video mode. If the data of the current block stems from film mode, two (A+B) or three (A+B+A) fields relate to the same motion phase. In contrast, in video mode each field relates to a different motion phase. The film/video mode bit (Bₘ) is preferably defined as follows:
0=video camera
1=motion picture film

In case of motion picture data, a three bit phase information (Bₚ) is additionally provided. This three bit information (Bₚ) reflects the motion phase pattern of the current film data.

In contrast to interlaced video signals, motion picture data is composed of complete frames. The most wide spread frame rate of motion picture data is 24 Hz. When transforming motion picture data into an interlaced video sequence for display on a television receiver, the 24 Hz frame rate is converted into an interlaced video sequence by employing a “pull down” technique.

For converting motion picture film into interlaced PAL of a field rate of 50 Hz, a two-two pull down technique is employed. The two-two pull down technique generates two fields out of each film frame. The motion picture film is played at 25 frames per second. Consequently, two succeeding fields contain information originating from the same frame.

When converting motion picture into NTSC having a field rate of 60 Hz, the frame rate of 24 Hz is converted into a 60 Hz field rate employing a three-two pull down technique. This three-two pull down technique generates two video fields from a given motion picture frame and three video fields from the next motion picture frame. As can be learned from the pull down techniques described above the resulting video sequences include pairs or triplets of adjacent fields reflecting an identical motion phase. The pull down techniques employed for converting motion picture frames into video fields in accordance with the PAL or NTSC standard are illustrated in FIG. 3.

Motion phases, reflected by the motion phase bits (Bₚ), are illustrated, by way of example, in FIG. 4. While the first column differentiates the individual bit combinations provided for PAL and NTSC motion phases, the respective motion phase sequences are illustrated in column four. The second column represents a respective three bit encoding thereof and the third column the according hexadecimal value.

Present picture quality improvement algorithms have to cope with irregular or defective auxiliary information, in particular for the still/motion indication, the film/video mode indication, and/or the motion phase indication. These irregularities result in a respectively impaired picture quality.

The present invention removes such irregularities by applying a filtering to a field of auxiliary information items. For this purpose, the present invention exploits the spatial neighborhood of each auxiliary data item in order to detect irregular data items. An example for removing irregular data items is illustrated in FIG. 5.

FIG. 5 illustrates a field of 20×16 blocks. The indicated example relates to binary indication such like a mode/still data indication or a film/video mode indication. While all white colored blocks relate to a binary value of zero, the black colored blocks relate to a binary value of one. Further, the dashed blocks of FIG. 5 also represent a binary value of one, however only having a width of one block. These blocks are detected and removed by either horizontal filtering (X₂, X₄) or by vertical filtering (X₁, X₃). Some of the irregularities can be removed by horizontal or alternatively by vertical filtering (X₅). The single blocks located at the borders of the illustrated field of data items are only removed by either applying a horizontal (X₁) or vertical filtering (X₂).

An example of the application of horizontal filter is illustrated in FIG. 6. A current pattern of three bits B2, B3, B4 is evaluated. The data values at positions B2, B3 and B4 are compared and upon detecting the centre value B3 to differ from the neighboring values B2, B4, the center value B3 is replaced by the value of the neighboring data items. Consequently, if the horizontal filter detects an irregularity in a binary sequence of “010” or “101”, this irregularity is changed to a sequence of “000” or “111”. In a corresponding manner, the evaluated sequence for detecting and removing an irregularity may have a larger width such as, for instance, 5 data items B1-B5. Accordingly, an irregularity in the binary sequence “00100” or “11011” is changed to “00000” or “11111”, respectively.

The processing for three data items as evaluated above is illustrated in FIG. 7. In step S10, an irregularly pattern is compared with a current data value at block positions B2, B3, and B4. If the center pattern B3 is different from the neighboring patterns B2, B4, an irregularity is detected and replaced by the value of the neighboring position in step S20. In contrast, if no irregularity is detected, the current data item is not changed (step S30).

The mode processing for Bₘ is similar to the processing for Bₛ.

The filtering process for the motion phase data items, described in connection with FIG. 8, differs slightly from the above process. The motion phase indication is preferably represented by a three bit value (Bₚ). In addition, the motion phases are directly dependent on the detected film/video mode. If the film/video mode information (Bₘ) is changed due to an irregularity detection in step S10, the respective motion phase (Bₚ) is changed accordingly in step S60 (cf. FIG. 8). Upon changing a film/video mode indication due to a detected irregularity, a new motion phase value is to be calculated based on the motion phase of the previous and subsequent block B2, B4. These two motion phases are averaged and round up to obtain the phase information for intermediate block B3. On the other hand, if the film/video mode value is not changed (step S30), the motion phase information is also maintained (step S70).

While the filtering as described by way of example with reference to horizontal filtering in FIG. 6, FIG. 7 and FIG. 8, a vertical filtering is performed in a respective manner. However, the hardware effort slightly increases, as a horizontal filtering operation only requires a memory capacity for a number of data items corresponding to the number of blocks evaluated, i.e. preferably three adjacent blocks. In contrast, a vertical filtering operation requires a memory capacity for storing data items of a respective number of rows, i.e. preferably two rows of blocks and an additional block for evaluating three vertically adjacent blocks. This memory requirement is illustrated in FIG. 9.

Reference numeral 900 designates the field of auxiliary data of a complete image. The data items 940, to be stored for processing the vertically adjacent data items 910, 920 and 930, are marked as grey colored blocks in FIG. 9.

The above described filtering operations are applicable to all block positions, except the border rows and border columns. In order to appropriately process these blocks, either the vertical or the horizontal filtering operation is disabled, due to a lack of neighbouring data. For the first and the last row, the vertical filtering is disabled and for the first and the last column the horizontal filtering is disabled.

According to a preferred embodiment, a plurality of irregularity patterns are stored in a look-up-table. A pattern to be evaluated is compared to a set of stored irregularity patterns. In case a current pattern matches one of the stored patterns, an irregularity is detected and removed from the field of data items.

Preferably, the recorded irregularity patterns have stored associated replacement patterns. These replacement patterns can be used as an alternative embodiment to the replacement processing described in connection with FIG. 6, FIG. 7 and FIG. 8.

The use of a look-up-table further enables to employ two dimensional irregularity patterns, for instance, block patterns of a 4×4 block size. An example thereof is indicated by X₆ in FIG. 5. Two dimensional block patterns can eliminate with more accuracy diagonal, horizontal and vertical and other kinds of unwanted auxiliary data configurations.

Summarizing, the present invention relates to a pre-processing of auxiliary data of a video sequence in order to enable improved processing results for applying picture improvement algorithms. Irregularities occurring within an auxiliary data field providing data items on a block basis are detected and removed. In particular, a film/video mode indication or a motion/still indication is processed accordingly. The removal of irregularities enables a respective improved image processing, for instance, interpolation processing during up-conversion and interlaced/progressive conversion.

1. A method for processing auxiliary information of a sequence of video images, each video image being divided into a plurality of blocks, the method comprising the steps of:
receiving a field of auxiliary information including an information item for each of the blocks of an image, and
subjecting said received field of auxiliary information to filtering in order to detect and eliminate an irregularity.

2. A method according to claim 1, wherein said auxiliary information being characteristic information of said video sequence.

3. A method according to claim 1, wherein said auxiliary information indicating whether or not an image block containing motion or still image data.

4. A method according to claim 3, wherein a single bit is provided for each block to indicate motion or still image data.

5. A method according to claim 1, wherein said auxiliary information indicating whether or not an image block containing film mode or video mode data.

6. A method according to claim 5, wherein a single bit is provided for each block to indicate film mode or video mode.

7. A method according to claim 5, wherein said auxiliary information further containing phase information indicating the individual motion scheme of a film mode block.

8. A method according to claim 7, wherein at least three bits are provided for each block to indicate the individual motion scheme.

9. A method according to claim 8, wherein said at least three bits include two bit combinations representing a PAL motion pattern.

10. A method according to claim 8, wherein said at least three bits include five bit combinations representing a NTSC motion pattern.

11. A method according to claim 8, wherein said at least three bits include a bit combination representing an image scene change.

12. A method according to claim 1, wherein said filtering detecting and eliminating irregularities in a row or column direction.

13. A method according to claim 12, wherein individual auxiliary data items are detected and eliminated which do not have at least two neighbouring data item of a corresponding value either in horizontal or in vertical direction.

14. A method according to claim 12, wherein individual auxiliary data items are detected and eliminated which do not have at least a single neighbouring data item of a corresponding value in horizontal and at least a single neighbouring data item of a corresponding value in vertical direction.

15. A method according to claim 12, wherein individual auxiliary data items are detected and eliminated which do not have at least two corresponding adjacent data items.

16. A method according to claim 1, wherein a detected irregular data item is eliminated by replacing the data item with the respective data item of a neighbouring block.

17. A method according to claim 1, wherein said detection step comprising the steps of:
comparing a current pattern of block data with a pre-stored irregularity pattern, and
replacing the current pattern upon detecting the current pattern to match a pre-stored irregularity pattern.

18. A method according to claim 17, wherein the replacement pattern is stored in association with the respective irregularity pattern.

19. A method according to claim 17, wherein said current pattern having a length between 3 or 5 data items, in particular 3 data items.

20. A method according to claim 17, wherein said current pattern extending two-dimensional.

21. A method for interpolating a sequence of video images based on motion compensation, wherein said interpolator processes received auxiliary data in accordance with the processing method of claim 1.

22. A signal processor for processing auxiliary information of a sequence of video images, the signal processor receiving a field of auxiliary information wherein each video image being divided into a plurality of blocks and said field of auxiliary information including an information item for each of the blocks of an image, the signal processor comprising a filter means for subjecting said received field of auxiliary information to filtering in order to detect and eliminate an irregularity.

23. A signal processor according to claim 22, wherein said auxiliary information being characteristic information of said video sequence.

24. A signal processor according to claim 22, wherein said auxiliary information indicating whether or not an image block containing motion or still image data.

25. A signal processor according to claim 24, wherein a single bit is provided for each block to indicate motion or still image data.

26. A signal processor according to claim 22, wherein said auxiliary information indicating whether or not an image block containing film mode or video mode data.

27. A signal processor according to claim 26, wherein a single bit is provided for each block to indicate film mode or video mode.

28. A signal processor according to claim 26, wherein said auxiliary information further containing phase information indicating the individual motion scheme of a video mode block.

29. A signal processor according to claim 28, wherein at least three bits are provided for each block to indicate the individual motion scheme.

30. A signal processor according to claim 29, wherein said at least three bits include two bit combinations representing a PAL motion pattern.

31. A signal processor according to claim 29, wherein said at least three bits include five bit combinations representing a NTSC motion pattern.

32. A signal processor according to any of claim 29, wherein said at least three bits include a bit combination representing an image scene change.

33. A signal processor according to claim 22, wherein said filter means performing a filter operation in a row or column direction.

34. A signal processor according to claim 33, wherein said filter means detecting and eliminating individual auxiliary data items which do not have at least two neighbouring data items of a corresponding value either in horizontal or in vertical direction.

35. A signal processor according to claim 33, wherein said filter means detecting and eliminating individual auxiliary data items which do not have at least a single neighbouring data item of a corresponding value in horizontal and at least a single neighbouring data item of a corresponding value in vertical direction.

36. A signal processor according to claim 33, wherein said filter means detecting and eliminating individual auxiliary data items which do not have at least two corresponding adjacent data items.

37. A signal processor according to claim 22, wherein said filter means eliminating a detected irregular data item by replacing the data item with the respective data item of a neighbouring block.

38. A signal processor according to claim 22, wherein said filter means comprising:
a memory for storing at least one irregularity pattern,
a comparator for comparing a current pattern of neighbouring block data with said pre-stored irregularity pattern, and
a replacing unit for replacing the current pattern upon detecting the current pattern to match a pre-stored irregularity pattern.

39. A signal processor according to claim 38, wherein said memory further storing a replacement pattern in association with the respective irregularity pattern.

40. A signal processor according to claim 38, wherein said current pattern having a length between 3 or 5 data items, in particular 3 data items.

41. A signal processor according to claim 38, wherein said current pattern extending two-dimensional.

42. An interpolator for interpolating a sequence of video images based on motion compensation, said interpolator including a signal processor in accordance with claim 22 for processing received auxiliary data for performing said motion compensated interpolation.
